(19) United States
(12) Patent Application Publication
(10) Pub. No.: US 2012/0041803 A1
(43) Pub. Date: Feb. 16, 2012

(54) CUSTOMER VALUE OPPORTUNITY SYSTEM

(75) Inventors: Milton Merl, New York, NY (US); Matthew John Symons, Oakland, CA (US)

(73) Assignee: Accenture Global Services GmbH, Schaffhausen (CH)

(21) Appl. No.: 12/853,934

(22) Filed: Aug. 10, 2010

(51) Int. Cl. G06Q 30/00

(52) U.S. Cl. 705/14.1; 705/14.4; 705/26.3

(57) ABSTRACT

A system determines one or more winning candidate bids and includes an offer receipt module that creates an offer which includes a request for a demand shaping tactic, a type of product, a demand opportunity group, and a desired demand response. A customer potential scoring module determines a customer potential score for the offer based on the demand opportunity group and the demand shaping tactic. A bid receipt module receives a plurality bids for a plurality of different offers including the offer. A bid matching module determines one or more matching bids of the plurality of bids based on the demand shaping tactic, the type of product, the demand opportunity group, and the desired demand response of the offer. A bid determination module determines one or more winning candidate bids based on the customer potential score, ad yield of the winning candidate bid, and customer lifetime value.

### BACKGROUND

Retailers are investing more discreetly in strategies to gain and keep customers based on their unique behaviors and needs. Traditionally, retailers have implemented retailer loyalty and rewards programs as well as online retail channels in order to gain and keep customers. Retailers are now investing in new strategies to attract customers, while attempting to shape customer demand for specific products. Some of these strategies include learning the unique needs and behaviors of the customers with the intention of growing customer lifetime value. Customer lifetime value is the present value of the future cash flows related to a customer relationship.

Manufacturers are also investing in strategies to gain and keep customers and grow customer lifetime value. Traditionally, manufacturers have relied heavily on advertisements, promotions and coupons to attract customers to their products and shape customer demand. More recently, manufacturers have started to invest in other strategies such as acquiring optimal positions on store shelves for their products, paid online search strategies and online advertisements in order to gain and keep customers as well as shape customer demand.

However, retailers and manufacturers must invest heavily in these strategies without being able to ensure that these strategies are indeed influencing customer demand and customer lifetime value. Moreover, it is difficult for retailers and manufacturers to determine whether they are receiving a return on their investment when implementing these strategies since their return on investment may depend on highly variable customer behavior. Because of the difficulty retailers and manufacturers have in determining the effect of their marketing investment strategies, they may be implementing such strategies without realizing a sufficient return on investment.

### SUMMARY OF THE INVENTION

According to an embodiment, a customer value opportunity system for determining one or more winning candidate bids includes an offer receipt module, a customer potential scoring module, a bid receipt module, a bid matching module and a bid determination module. The offer receipt module is configured to create an offer, the offer including a request for a demand shaping tactic, a type of product, a demand opportunity group, and a desired demand response. The customer potential scoring module is configured to determine a customer potential score for the offer based on the demand opportunity group and the demand shaping tactic of the offer. The bid receipt module is configured to receive a plurality bids for a plurality of different offers including the offer. The bid matching module is configured to determine one or more matching bids of the plurality of bids based on the demand shaping tactic, the type of product, the demand opportunity group, and the desired demand response of the offer. The bid determination module is configured to determine one or more winning candidate bids, wherein one or more of the matching bids is a winning candidate bid if the customer potential score of the offer exceeds a predetermined threshold and the ad yield of the winning candidate bid is higher than an effect on customer lifetime value.

According to an embodiment, a method for determining one or more winning candidate bids includes receiving offer information including a request for a demand shaping tactic, wherein the demand shaping tactic is for a type of product, a demand opportunity group, and a desired demand response and creating an offer based on the offer information, the offer including the request for a demand shaping tactic, the type of product, the demand opportunity group, and the desired demand response. The method further includes determining a customer potential score for the offer based on the demand opportunity group and the demand shaping tactic of the offer and receiving a plurality bids for a plurality of different offers including the offer. The method also includes determining one or more matching bids of the plurality of bids based on the demand shaping tactic, the type of product, the demand opportunity group, and the desired demand response of the offer and determining, by a computer system, one or more winning candidate bids, wherein the one or more matching bids is a winning candidate bid if the customer potential score of the offer exceeds a predetermined threshold and the ad yield of the winning candidate bid is higher than an effect on customer lifetime value. According to an embodiment, the method described above may be embodied in a computer program stored on a non-transitory computer readable medium, which when executed by a computer system performs the method.

### BRIEF DESCRIPTION OF DRAWINGS

The embodiments of the invention will be described in detail in the following description with reference to the following figures.

FIG. 1 illustrates a customer value opportunity system for determining one or more winning candidate bids, according to an embodiment;

FIG. 2 illustrates a method for determining one or more winning candidate bids, according to an embodiment; and

FIG. 3 illustrates a computer system configured to provide a hardware platform for the customer value opportunity system shown in FIG. 1, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments. Also, the embodiments described herein may be used with each other in various combinations.

### 1. Overview

According to embodiments, interactions among retailers, manufacturers and customers are coordinated to generate a new revenue stream that takes advantage of customer value opportunities. A customer value opportunity is an identified opportunity to influence customer demand determined based on customer-centric modeling. Customer-centric modeling indicates a next most profitable action to take with regard to product recommendations to make to a customer based on a goal of growing customer lifetime value. Customer lifetime value is the present value of the future cash flows related to a customer relationship. An identified opportunity to influence customer demand is an opportunity to implement the next most profitable action to take in the form of demand shaping tactics such as marketing materials, advertising, promotions, discounts, coupons, etc., for a specific type of product for a specific demand opportunity group to bring about a desired demand response. A demand opportunity group is a group of customers with similar characteristics. For example, a demand opportunity group may include customers who are between the ages of 18 to 24, prefer sweetened cereal and consume only specific brands of cereal. Retailers and manufacturers may group their customers into demand opportunity groups. A desired demand response is an action that is to be taken by the demand opportunity group that is desired by a retailer or manufacturer. For example, the desired demand response may be for the demand opportunity group to purchase a product.

According to an embodiment, a bidding system is used to generate the new revenue stream. A retailer may bid against other retailers and manufacturers for a customer value opportunity in response to an offer posted by a manufacturer. Conversely, a manufacturer may bid against other manufacturers and retailers for a customer value opportunity in response to an offer posted by a retailer. An offer may be an invitation to bid on the customer value opportunity and bring about a desired demand response. Therefore, the offer may be an invitation to perform the next most profitable action determined by customer-centric modeling, i.e. provide a demand shaping tactic to influence customer demand for a specific type of product for a specific demand opportunity group to bring about a desired demand response. A bid may be a response to an offer and may provide the demand shaping tactic for the specific type of product for the specific demand opportunity group requested in the offer in order to bring about the desired demand response. The bid includes an amount to be paid to the offeror if the demand shaping tactic is used by the offeror.

The system provides an opportunity for retailers and manufacturers to post an offer for a customer value opportunity and permits other retailers and manufacturers to respond to the offer with a bid to influence customer demand and bring about the desired demand response as requested in the offer. The system may determine one or more winning candidate bids based on predefined criteria. Thus, the retailer or manufacturer receives the investment as revenue from the retailer or manufacturer whose bid is determined a winning candidate bid and accepted by the retailer or the manufacturer.

The retailer or the manufacturer providing the bid in response to the offer may want to determine whether it is in their best interest to bid, i.e. pay the offeror to use the demand shaping tactic described in the bid, and how much to bid on the offer. Therefore, the demand opportunity group to which the offer is related may be given a customer potential score by the system, according to an embodiment. The customer potential score is an indicator of a potential return on investment from the customers in the demand opportunity group to which the offer is related and is used to determine which bid is a winning candidate bid, if any. Thus, the customer potential score varies by demand opportunity group.

The customer potential score for the demand opportunity group is a product of a performance objective. The performance objective is a measure tied to the desired demand response for the offer. More specifically, the retailers' or manufacturers' desire to increase performance metrics such as: (1) share of trips to the store (trip frequency and repeat rate), (2) share of categories bought (how much of the customer requirements are met at the store shopping experience), and (3) share of value received (the ratio of cost to margin received after discounts of foods bought by the customer). To increase any one of the three customer performance metrics, retailers and manufacturers may configure factors of the customer potential score for the demand opportunity group. The customer potential score is based upon a variety of factors for which weightings may be specified. An example of factors may include product category, seasonality, competitor analysis, supply chain inventory, shelf-life calculations, demand implications, etc. Retailers and manufacturers may specify a weighting for these factors for the demand opportunity group for which the offer is desired. By specifying the weightings for the factors, the customer potential score may be increased or decreased for the demand opportunity group.

Thus, the customer potential score is a reflection of the customers' in the demand opportunity group potential to change behavior and the typical time that the behavior change stays in place. For example, if the demand opportunity group has a high customer potential score, the customers in the demand opportunity group are more likely to switch brands of the specific type of product in response to experiencing the demand shaping tactic in the offer. There may be a different customer potential score for different demand shaping tactics, such as marketing materials, advertising, promotions, discounts, coupons, etc. The bid from the retailer or manufacturer may include a minimum customer potential score that reflects whether the bidder, e.g. the retailer or the manufacturer, will want to bid on the offer. For example, if the minimum customer potential score accepted by the bidder is 38, and the offer has a customer potential score of only 25, the bidder may not accept the offer since the minimum customer potential score of the bid has not been met by the customer potential score of the offer.

Moreover, the demand shaping tactic submitted in the bid may negatively affect customer lifetime value. For example, a winning candidate bid that is accepted may direct a customer to purchase from another entity. Thus, before the winning candidate bid is accepted, a determination is made whether the winning candidate bid results in more profits for the offeror, e.g., ad yield, than a potential effect on customer lifetime value in terms of profits. Once this determination is made, if the ad yield is higher than the negative effect on customer lifetime value in terms of dollars, the winning candidate bid may be accepted.

According to an aspect of this disclosure, a method for obtaining, storing and viewing storing user data in an bidding environment is provided. The method includes providing a user interface on a user computer. The method further includes determining whether a bid meets the criteria of an offer which indicates whether there is synchronization between data in two databases. The method also includes obtaining user data with the user interface. In addition, the method includes storing the user data in the user database. Thus, the method may decrease the mental and physical effort required from a user in order to perform a task (e.g. storing data), since the user does not need to worry about where data is stored. In addition, the offers and bids may enable an improved, continued man-machine interaction, by facilitating the storage and synchronization of data.

### 2. System

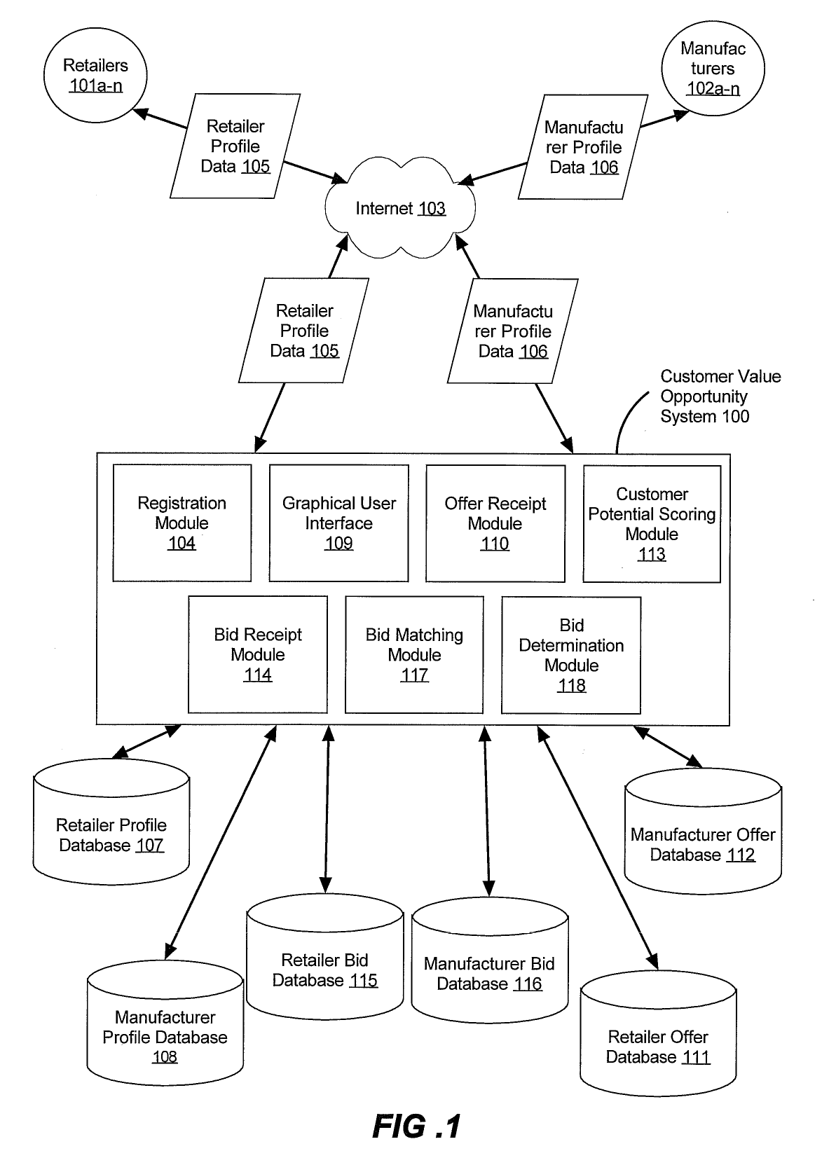

FIG. 1 illustrates a customer value opportunity system 100, according to an embodiment. FIG. 1 includes retailers 101a-n and manufacturers 102a-n that may access the customer value opportunity system 100 via a network, such as Internet 103 or other type of network. The retailers 101a-n and the manufacturer 102a-n may be any entity operable to post offers and/or bids to the customer value opportunity system 100. The customer value opportunity system 100 includes a registration module 104, a retailer profile database 107, a manufacturer profile database 108, a graphical user interface 109, an offer receipt module 110, a retailer offer database 111, a manufacturer offer database 112, a customer potential scoring module 113, a bid receipt module 114, a retailer bid database 115, a manufacturer bid database 116, a bid matching module 117 and a bid determination module 118.

A retailer, for example, retailer 101a, and/or a manufacturer, for example manufacturer 102a, may register with the customer value opportunity system 100 in order to access the customer value opportunity system 100. The retailer 101a or the manufacturer 102a may access the customer value opportunity system 100 in order to post an offer, to determine if a bid was placed in response to a previously posted offer, to determine one or more winning candidate bids, to post a bid in response to an offer, etc. As described above, an offer may be an invitation to bid on a customer value opportunity, i.e. a next most profitable action, and bring about a desired demand response determined based on customer-centric modeling. Customer-centric modeling indicates a next most profitable action to take with regard to product recommendations to make to a customer based on a goal of growing customer lifetime value. Customer lifetime value is the present value of the future cash flows related to a customer relationship. Therefore, the offer may be an invitation to perform the next most profitable action determined by customer-centric modeling, which may include providing a demand shaping tactic to influence customer demand for a specific type of product for a specific demand opportunity group to bring about a desired demand response. As described above, a bid may be a response to an offer and may provide the demand shaping tactic for the specific type of product for the specific demand opportunity group requested in the offer in order to bring about the desired demand response. The bid includes a minimum customer potential score. The bid includes an amount to be paid to the offeror if the demand shaping tactic is used by the offeror.

To register with the customer value opportunity system 100, the retailer 101a may submit a retailer profile data 105 to the registration module 104. The retailer profile data 105 may include a retailer name, a retailer address, a login ID, a password and other information about the retailer 101a. The registration module 104 stores the retailer profile data 105 in the retailer profile database 107. Once the retailer 101a is registered with the customer value opportunity system 100, the retailer 101a may access the customer value opportunity system 100. The retailer 101a may access the customer value opportunity system 100 by providing a login ID and a password to the graphical user interface 109 that matches the login ID and the password in the retailer profile data 105 for the retailer 101a.

To register with the customer value opportunity system 100, the manufacturer 102a may submit a manufacturer profile data 106 to the registration module 104. The manufacturer profile data 106 may include a manufacturer name, a manufacturer address, a login ID, a password and other information about the manufacturer 102a. The registration module 104 stores the manufacturer profile data 106 in the manufacturer profile database 108. Once the manufacturer 102a is registered with the customer value opportunity system 100, the manufacturer 102a may access the customer value opportunity system 100. The manufacturer 102a may access the customer value opportunity system 100 by providing a login ID and a password to the graphical user interface 109 that matches the login ID and the password in the manufacturer profile data 106 for the manufacturer 102a.

The offer receipt module 110 receives offer information entered into the graphical user interface 109 by the retailer 101a or the manufacturer 102a. The offer information may include a request for a demand shaping tactic such as marketing materials, advertising, promotions, discounts, coupons, etc. The offer information may also include a type of product, a demand opportunity group, and a desired demand response for which the demand shaping tactic is requested. The offer receipt module 110 may create an offer from an offer template based on the offer information. For example, the offer is created when the offer information is populated in the offer template by the offer receipt module 110. The offer information, when entered by the retailer 101a, is saved as an offer in the retailer offer database 111. When entered by the manufacturer 102a, the offer information is saved as an offer in the manufacturer offer database 112. Thus, the retailer offer database 111 includes a variety of offers from various the retailers 101a-n. The manufacturer offer database 112 includes a variety of offers from the various manufacturers 102a-n.

Once the offer is saved in the retailer offer database 111 or the manufacturer offer database 112, the offer may be posted to an electronic board in the customer value opportunity system 100 or may be sent electronically to the retailers 101a-n and the manufacturers 102a-n via text, email, automated message alert, etc. to be available for viewing. The offer may be viewable by the other retailers 101a-n and/or the other manufacturers 102a-n registered with the customer value opportunity system 100, or a subset thereof.

The customer potential scoring module 113 determines a customer potential score for the offer available for viewing, based on the demand opportunity group and the demand shaping tactic related to the viewable offer. The customer potential score is an indicator of a potential return on investment from the customers in the demand opportunity group of the viewable offer. The customer potential score for the demand opportunity group in the offer is a product of a performance objective. The performance objective is a measure tied to the retailers' or manufacturers' desired demand response. More specifically, the retailers' or manufacturers' desire to increase one or more customer performance metrics, such as: (1) share of trips to the store (trip frequency and repeat rate), (2) share of categories bought (how much of the customer requirements are met at the store shopping experience), and (3) share of value received (the ratio of cost to margin received after discounts of foods bought by the customer).

Retailers and manufacturers may configure factors of the customer potential score for the demand opportunity group to increase any one of the three customer performance metrics through the graphical user interface 109. The customer potential score is based upon a variety of factors for which weightings may be specified. An example of factors may include product category, seasonality, competitor analysis, supply chain inventory, shelf-life calculations, demand implications, etc. Retailers and manufacturers may specify a weighting for these factors for the demand opportunity group for which the offer is desired. By specifying the weightings for the factors, the customer potential score may be increased or decreased for the demand opportunity group.

Thus, the customer potential score determined by the customer potential scoring module 113 may be based on weightings entered into the graphical user interface 109. If weightings are not entered into the graphical user interface 109, the customer potential score is determined by the customer potential scoring module 113 based on default weightings for the factors. Therefore, the customer potential score is a reflection of the customers' in the demand opportunity group potential to change behavior and the typical time that the behavior change stays in place. For example, if the demand opportunity group has a high customer potential score, the customers in the demand opportunity group are more likely to switch brands of the specific type of product in response to the demand shaping tactic in the offer. There may be a different customer potential score for different demand shaping tactics such as marketing materials, advertising, promotions, discounts, coupons, etc.

The bid receipt module 114 receives a plurality of bids from the retailers 101a-n and/or the manufacturers 102a-n. Thus, the bid receipt module 114 receives the bids entered into the graphical user interface 109 by the retailers 101a-n and/or the manufacturers 102a-n. The bids received by the bid receipt module 114 may be in response to any of the variety of the viewable offers. The bids may include a demand shaping tactic such as marketing materials, advertising, promotions, discounts, coupons, etc. The bids may also include a type of product, a demand opportunity group, a demand response, a minimum customer potential score and an amount to be paid to the offeror if the demand shaping tactic is used by the offeror. Once the bid is created, the bid is stored. The bids received from the retailers 101a-n are saved in the retailer bid database 115. The bids received from the manufacturers 102a-n are saved in the manufacturer bid database 116. Thus, the retailer bid database 115 includes a variety of bids from the various retailers 101a-n. The manufacturer bid database 116 includes a variety of bids from various the manufacturers 102a-n.

The bid matching module 117 determines one or more matching bids of the plurality of bids in either the retailer bid database 115 or the manufacturer bid database 116 for a viewable offer of the plurality of viewable offers. For instance, if the viewable offer was posted by the retailer 101a, the one or more matching bids may be determined from the retailer bid database 115 and the manufacturer bid database 116. Conversely, if the viewable offer was posted by a manufacturer 102a, the one or more matching bids may be determined from the retailer bid database 115 and the manufacturer bid database 116. The one or more matching bids are determined based on whether the demand shaping tactic, the type of product, the demand opportunity group, and the demand response of the bid matches the demand shaping tactic, the type of product, the demand opportunity group, and the desired demand response in the viewable offer. If these parameters match, the bid is considered a matching bid.

Once one or more matching bids are determined by the bid matching module 117, the bid determination module 118 determines if the one or more matching bids are winning candidate bids. Each of the one or more matching bids are winning candidate bids if the customer potential score in the viewable offer exceeds a predetermined threshold. The predetermined threshold is the minimum customer potential score in each of the one or more matching bids.

The demand shaping tactic submitted in the winning candidate bid may negatively affect customer lifetime value. For example, though a retailer may receive profits, i.e. ad yield, from using the demand shaping tactic in the winning candidate bid submitted by another retailer, the retailer may lose the customer permanently to the other retailer that submitted the winning candidate bid. Thus, accepting the winning candidate bid negatively affects customer lifetime value, even thought the ad yield was received. Therefore, before the winning candidate bid is accepted, a determination is made by the bid determination module 118 whether the profits from the winning candidate bid, i.e. ad yield, are more than a potential effect on customer lifetime value in terms of profits. Once this determination is made, if the ad yield is higher than the negative effect on customer lifetime value in terms of dollars, the winning candidate bid may be accepted. The retailer 101a or the manufacturer 102a that posted the viewable offer is notified if there is one or more winning candidate bids via email, alert, SMS, text, etc.

### 3. Method

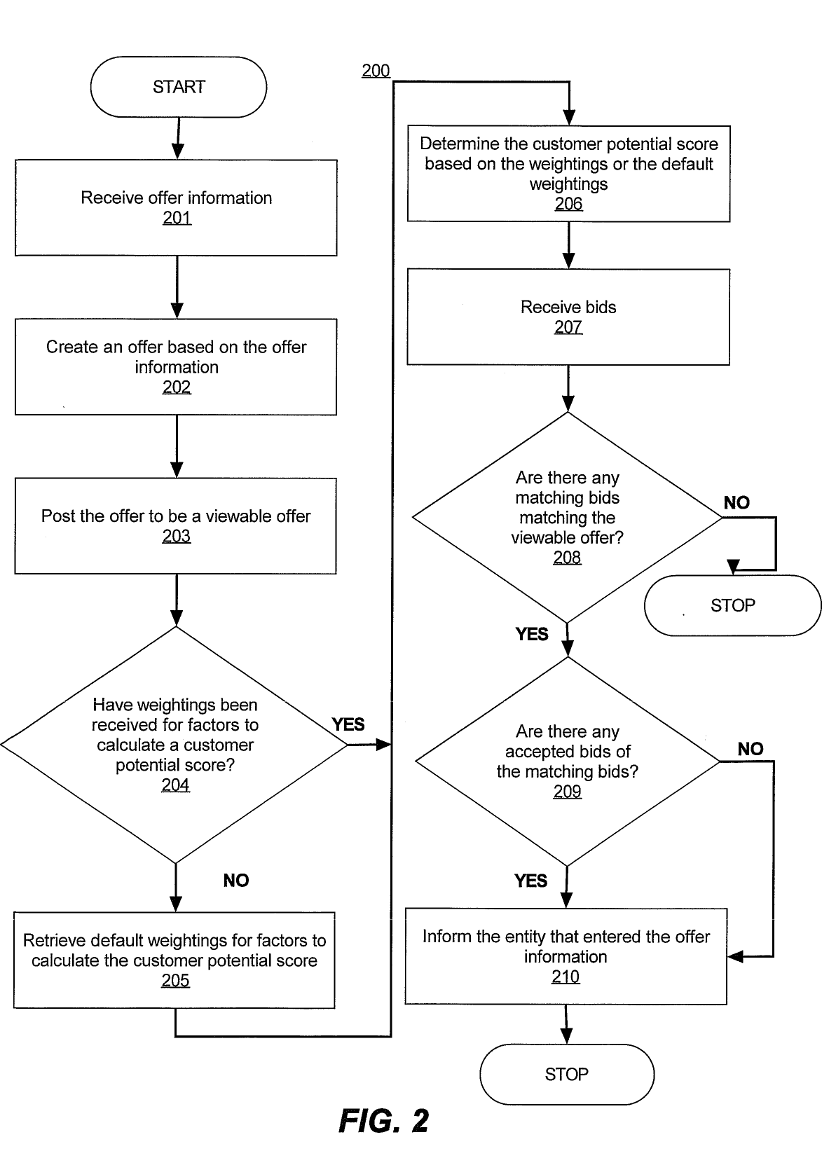

FIG. 2 illustrates method 200 for determining one or more winning candidate bids, according to an embodiment. The method 200 is described with respect to the customer value opportunity system 100 shown in FIG. 1 by way of example and not limitation. The method 200 may be performed by other systems.

At step 201, the customer value opportunity system 100 receives offer information. The offer information may be entered into the customer value opportunity system 100 by a retailer or by a manufacturer. The offer information may include a request for a demand shaping tactic such as marketing materials, advertising, promotions, discounts, coupons, etc. The offer information may also include a type of product, a demand opportunity group, and a desired demand response for which the demand shaping tactic is requested.

At step 202, the customer value opportunity system 100 creates an offer from the offer information. As described above, the offer may be an invitation to bid on a customer value opportunity, i.e. a next most profitable action, and bring about a desired demand response determined based on customer-centric modeling. Therefore, the offer may be an invitation to perform the next most profitable action determined by customer-centric modeling, which may include providing a demand shaping tactic to influence customer demand for a specific type of product for a specific demand opportunity group to bring about a desired demand response. The offer may be created when the offer information is populated in an offer template and saved as an offer. There may be a variety of offers from various retailers and various manufacturers.

At step 203, the offer may be posted to an electronic board (e.g., displayed on a web site) in the customer value opportunity system 100 or may be sent electronically to the retailers or the manufacturers via text, email, automated message alert, etc. to be available for viewing. The offer may be viewable by the other retailers and/or the other manufacturers registered with the customer value opportunity system 100, or a subset thereof.

At step 204, the customer value opportunity system 100 determines whether weightings were received by the customer value opportunity 100 for factors of a customer potential score. A customer potential score for the offer based on the demand opportunity group and the demand shaping tactic related to the viewable offer. The customer potential score for the demand opportunity group may be based on a performance objective. The performance objective is a measure tied to the retailers' or manufacturers' desired demand response. For example, the retailers' or manufacturers' desire to increase one of three core customer performance metrics: (1) share of trips to the store (trip frequency and repeat rate), (2) share of categories bought (how much of the customer requirements are met at the store shopping experience), and (3) share of value received (the ratio of cost to margin received after discounts of foods bought by the customer). There may be a different customer potential score for different demand shaping tactics such as marketing materials, advertising, promotions, discounts, coupons, etc. Retailers and manufacturers may configure the factors of the customer potential score for the demand opportunity group to increase any one of the three customer performance metrics through a graphical user interface. The customer potential score is based upon a variety of factors for which weightings may be specified. An example of factors may include product category, seasonality, competitor analysis, supply chain inventory, shelf-life calculations, demand implications, etc. Retailers and manufacturers may specify a weighting for these factors for the demand opportunity group for which the offer is desired. By specifying the weightings for the factors, the customer potential score may be increased or decreased for the demand opportunity group. If the weightings have not been received by the customer value opportunity system 100, the process proceeds to step 205. If the weightings have been received by the customer value opportunity system 100, the process proceeds to step 206.

At step 205, default weightings are retrieved by the customer value opportunity system 100. The process then proceeds to step 206.

At step 206, the customer potential score is determined by the customer value opportunity system 100 either based on the weightings received at step 205 or the default weightings received at step 206.

At step 207, the customer value opportunity system 100 receives a plurality of bids from the retailers and/or the manufacturers. The bids may be entered into the customer opportunity system 100 by the retailers and/or the manufacturers in response to any of the variety of viewable offers. As described above, the bid may be a response to an offer and may provide the demand shaping tactic for the specific type of product for the specific demand opportunity group requested in the offer in order to bring about the desired demand response. The bids may include a demand shaping tactic such as marketing materials, advertising, promotions, discounts, coupons, etc. The bids may also include a type of product, a demand opportunity group, a demand response and a minimum customer potential score. The bid includes an amount to be paid to the offeror if the demand shaping tactic is used by the offeror. There may be a variety of bids from various retailers and a variety of bids from various manufacturers.

At step 208, the customer value opportunity system 100 determines one or more matching bids of the plurality of bids for a viewable offer of the plurality of viewable offers. The one or more matching bids are determined based on whether the demand shaping tactic, the type of product, the demand opportunity group, and the demand response of the bid matches the demand shaping tactic, the type of product, the demand opportunity group, and the desired demand response in the viewable offer. If these parameters match, the bid is considered a matching bid. If there are no matching bids, the process ends at this step. If there is one or more matching bid, the process proceeds to step 210.

At step 209, the customer value opportunity system 100 determines if the one or more matching bids are winning candidate bids. For example, a matching bid may be considered a winning candidate bid if the customer potential score in the viewable offer exceeds a predetermined threshold. The predetermined threshold is the minimum customer potential score in the one or more matching bids.

The demand shaping tactic submitted in the winning candidate bid may negatively affect customer lifetime value. Thus, before the winning candidate bid may be accepted, a determination is made at step 209 whether the profits from the winning candidate bid, i.e. ad yield, are more than a potential effect on customer lifetime value in terms of profits. Once this determination is made, if the ad yield is higher than the negative effect on customer lifetime value in terms of dollars, the winning candidate bid may be accepted. Of course, there may be no winning candidate bids.

At step 210, the retailer or manufacturer that posted the viewable offer is notified of the one or more winning candidate bids via email, alert, SMS, text, etc. For example, if there is one or more winning candidate bids determined at step 209, the retailer or manufacturer that posted the viewable offer is notified of these. If, however, at step 209, no winning candidate bids were determined, the retailer or manufacturer that posted the viewable offer is notified that no winning candidate bids were determined.

### 4. Computer System

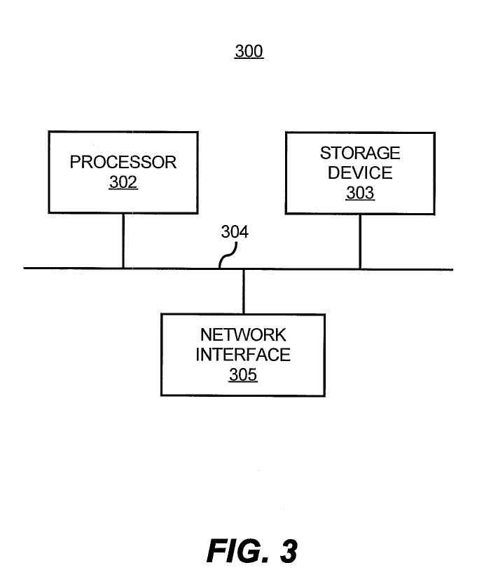

According to an embodiment, the customer value opportunity system 100 may also be software running on a computer system belonging to the retailer 101 or the manufacturer 102, a system accessed via the Internet, a web service, etc. FIG. 3 shows a computer system 300 that may be used as a hardware platform for the customer value opportunity system 100, according to an embodiment. The computer system 300 may be used as a platform for executing one or more of the steps, methods, modules and functions described herein that may be embodied as software stored on one or more computer readable mediums, which may be non-transitory, such as storage devices. The modules may be software, hardware or a combination of both software and hardware.

The computer system 300 includes a processor 302, unit or processing circuitry that may implement or execute software instructions performing some or all of the methods, functions and other steps described herein. Commands and data from the processor 302 are communicated over a communication bus 304. The computer system 300 also includes a computer readable storage device 303, such as random access memory (RAM), where the software and data for processor 302 may reside during runtime. The storage device 303 may also include non-volatile data storage. The computer system 300 may include a network interface 305 for connecting to a network. It will be apparent to one of ordinary skill in the art that other known electronic components may be added or substituted in the computer system 300.

While the embodiments have been described with reference to examples, those skilled in the art will be able to make various modifications to the described embodiments without departing from the scope of the claimed embodiments. Also, the embodiments described herein may be used to determine brands or products customers may switch to, the likelihood of a customer switching brands or products, etc.

What is claimed is:

1. A customer value opportunity system for determining one or more winning candidate bids, comprising:
an offer receipt module configured to create an offer, the offer including a request for a demand shaping tactic, a type of product, a demand opportunity group, and a desired demand response;
a customer potential scoring module configured to determine a customer potential score for the offer based on the demand opportunity group and the demand shaping tactic of the offer;
a bid receipt module configured to receive a plurality bids for a plurality of different offers including the offer;
a bid matching module configured to determine one or more matching bids of the plurality of bids based on the demand shaping tactic, the type of product, the demand opportunity group, and the desired demand response of the offer; and
a bid determination module executed by a computer system and configured to determine one or more winning candidate bids, wherein one or more of the matching bids is a winning candidate bid if the customer potential score of the offer exceeds a predetermined threshold and the ad yield of the winning candidate bid is higher than an effect on customer lifetime value.

2. The customer value opportunity system of claim 1, wherein the demand shaping tactic is a marketing material, promotion, advertisement, coupon or discount.

3. The customer value opportunity system of claim 1, wherein the demand opportunity group is a group of customers with similar characteristics.

4. The customer value opportunity system of claim 1, wherein each of the plurality of bids includes a demand shaping tactic, a type of product, a demand opportunity group, a demand response, the predetermined threshold and a price for the use of the demand shaping tactic.

5. The customer value opportunity system of claim 1, wherein a bid is one of the one or more matching bids if the demand shaping tactic, the type of product, the demand opportunity group, and the desired demand response of the offer matches a demand shaping tactic, a type of product, a demand opportunity group, and a demand response of the bid.

6. The customer value opportunity system of claim 1, wherein the predetermined threshold is a minimum customer potential score in each of the one or more matching bids.

7. The customer value opportunity system of claim 1, wherein the customer potential score is an indicator of a potential return on investment from customers in the demand opportunity group to which the offer is presented.

8. The customer value opportunity system of claim 1, wherein the desired demand response is an action desired to be taken by customers in the demand opportunity group.

9. A method for determining one or more winning candidate bids, comprising:
receiving offer information including a request for a demand shaping tactic, wherein the demand shaping tactic is for a type of product, a demand opportunity group, and a desired demand response;
creating an offer based on the offer information, the offer including the request for a demand shaping tactic, the type of product, the demand opportunity group, and the desired demand response;
determining a customer potential score for the offer based on the demand opportunity group and the demand shaping tactic of the offer;
receiving a plurality bids for a plurality of different offers including the offer;
determining one or more matching bids of the plurality of bids based on the demand shaping tactic, the type of product, the demand opportunity group, and the desired demand response of the offer; and
determining, by a computer system, one or more winning candidate bids, wherein the one or more matching bids is a winning candidate bid if the customer potential score of the offer exceeds a predetermined threshold and the ad yield of the winning candidate bid is higher than an effect on customer lifetime value.

10. The method of claim 9, wherein the demand shaping tactic is a marketing material, promotion, advertisement, coupon or discount.

11. The method of claim 9, wherein the demand opportunity group is a group of customers with similar characteristics.

12. The method of claim 9, wherein each of the plurality of bids includes a demand shaping tactic, a type of product, a demand opportunity group, a demand response, the predetermined threshold and a price for the use of the demand shaping tactic.

13. The method of claim 9, wherein a bid is one of the one or more matching bids if the demand shaping tactic, the type of product, the demand opportunity group, and the desired demand response of the offer matches a demand shaping tactic, a type of product, a demand opportunity group, and a demand response of the bid.

14. The method of claim 9, wherein the predetermined threshold is a minimum customer potential score in each of the one or more matching bids.

15. A non-transitory computer readable medium having stored thereon a computer executable program for determining one or more winning candidate bids, the computer executable program, when executed causes a computer system to perform a method comprising:
receiving offer information including a request for a demand shaping tactic, wherein the demand shaping tactic is for a type of product, a demand opportunity group, and a desired demand response;
creating an offer based on the offer information, the offer including the request for a demand shaping tactic, the type of product, the demand opportunity group, and the desired demand response;
determining a customer potential score for the offer based on the demand opportunity group and the demand shaping tactic of the offer;
receiving a plurality bids for a plurality of different offers including the offer;
determining one or more matching bids of the plurality of bids based on the demand shaping tactic, the type of product, the demand opportunity group, and the desired demand response of the offer; and
determining one or more winning candidate bids, wherein the one or more matching bids is a winning candidate bid if the customer potential score of the offer exceeds a predetermined threshold and the ad yield of the winning candidate bid is higher than an effect on customer lifetime value.

16. The computer readable medium of claim 15, wherein the demand shaping tactic is a marketing material, promotion, advertisement, coupon or discount.

17. The computer readable medium of claim 15, wherein the demand opportunity group is a group of customers with similar characteristics.

18. The computer readable medium of claim 15, wherein each of the plurality of bids includes a demand shaping tactic, a type of product, a demand opportunity group, a demand response, the predetermined threshold and a price for the use of the demand shaping tactic.

19. The computer readable medium of claim 15, wherein a bid is one of the one or more matching bids if the demand shaping tactic, the type of product, the demand opportunity group, and the desired demand response of the offer matches a demand shaping tactic, a type of product, a demand opportunity group, and a demand response of the bid.

20. The computer readable medium of claim 15, wherein the predetermined threshold is a minimum customer potential score in each of the one or more matching bids.
